(19) United States
(12) Patent Application Publication
(10) Pub. No.: US 2025/0181622 A1
(43) Pub. Date: Jun. 5, 2025

(54) METHOD AND SYSTEM FOR DIALOGUE DATA GENERATION AND PROCESSING

(71) Applicant: Hangzhou Alibaba International Internet Industry Co., Ltd., Hangzhou (CN)

(72) Inventors: Sen Liu, Hangzhou (CN); Linbo Jin, Hangzhou (CN)

(21) Appl. No.: 18/956,845

(22) Filed: Nov. 22, 2024

(30) Foreign Application Priority Data
Nov. 30, 2023 (CN) 202311624147.3

(51) Int. Cl. G06F 16/33; G06F 40/35

(52) U.S. Cl. CPC G06F 16/3344; G06F 40/35

(57) ABSTRACT

The application provides a method for generating dialogue data, a method for training a model, and a method for processing dialogues. The dialogue data generation method includes: obtaining a prompt template and a generation content dependency relationship corresponding to each of human-machine dialogue elements in a target scenario, wherein the human-machine dialogue elements at least include: user queries and response content; progressively generating generation content of the corresponding human-machine dialogue elements based on the prompt templates and a pre-trained large language model according to the generation content dependency relationships; generating multi-round dialogue data in the target scenario based on the generation content respectively corresponding to the user queries and the response content. This method enables the fully automatic generation of multi-round dialogue data in a target domain, eliminating the need for manual annotation, reducing the cost of acquiring multi-round dialogue data, and improving the efficiency of dialogue data acquisition.

### CROSS-REFERENCE TO RELATED APPLICATIONS

This application claims priority to Chinese Patent Application No. 202311624147.3, filed with the China National Intellectual Property Administration on Nov. 30, 2023, and entitled “Method for Dialogue Data Generation, System and Model Training Method, and Dialogue Processing Method,” which is incorporated herein by reference in its entirety.

### TECHNICAL FIELD

The present application relates to the field of computer technology, and in particular, to a method for generating dialogue data, a system for generating dialogue data, a method for training a model, a method for processing dialogues, an electronic device, and a storage medium.

### BACKGROUND

The implementation of multi-round online dialogue through chatbots has found widespread applications in various fields. For example, in the field of e-commerce, chatbots can be used to assist users and handle customer inquiries, thereby improving the operational efficiency of e-commerce platforms. However, traditional chatbots have limited comprehension abilities regarding user queries, and their responses to users' queries are often unsatisfactory. In other words, traditional chatbots can only handle a limited range of dialogue content during human-machine dialogues, making it difficult to provide precise services to users to obtain a suboptimal user experience. One of the key reasons for the inability of traditional chatbots to offer accurate services is the scarcity of dialogue data samples used to train the dialogue content generation models within these chatbots. In the current technology, the methods of manually annotating and generating dialogue data samples are inefficient and costly.

### SUMMARY

The embodiments of this application provide a method for generating dialogue data, which can automatically generate multi-round dialogue data for various scenarios within a target domain. This method is highly efficient and cost-effective, providing abundant dialogue data samples for training dialogue content generation models applicable to the target domain. As a result, the accuracy of response content generated based on user queries is further improved.

Accordingly, the embodiments of this application also provide a dialogue data generation system, a model training method, a dialogue processing method, an electronic device, and a storage medium to ensure the implementation and application of the aforementioned method.

To address the aforementioned issues, the embodiments of this application disclose a method for generating dialogue data, which includes the following steps:
obtaining a prompt template and a generation content dependency relationship corresponding to each of human-machine dialogue elements in a target scenario, wherein the human-machine dialogue elements at least include: user queries and response content;
progressively generating generation content corresponding human-machine dialogue elements based on the prompt templates and a pre-trained large language model according to the generation content dependency relationships;
generating multi-round dialogue data in the target scenario based on the generation content respectively corresponding to the user queries and the response content.

The embodiments of this application also disclose a model training method, which includes the following steps:
obtaining multiple sets of multi-round dialogue data in a target scenario, wherein each set of multi-round dialogue data includes multi-rounds of user queries and response content arranged in a logically progressive sequence;
constructing a dialogue content generation model based on a pre-trained large language model;
fine-tuning the dialogue content generation model based on the multi-round dialogue data until a prediction loss value of the dialogue content generation model satisfies a preset convergence condition, wherein the predicted loss value is calculated based on single-round dialogue prediction loss of each set of multi-round dialogue data, where the single-round dialogue prediction loss is negative log-likelihood average obtained by modeling predicted response content generated by the dialogue content generation model in response to the user queries in each round of the dialogue data.

The embodiments of this application also disclose a dialogue data processing method, which includes the following steps:
in response to receiving a current-round user query, obtaining dialogue data from a specified number of previous rounds of dialogue;
generating reply dialogue data to be responded to based on the current-round user query and the specified number of previous rounds of dialogue data, according to a logical progression;
invoking a pre-trained dialogue content generation model based on the reply dialogue data to obtain response content output by the dialogue content generation model;
responding to the current-round user query based on the response content.

The embodiments of this application also disclose a dialogue data generation system, which includes the following components:
a topic generation module, used to generate a third prompt based on a preset third prompt template, and invoke a pre-trained large language model based on the third prompt to output generation content of multiple dialogue topics within a target scenario generated by the pre-trained large language model;
a character setting generation module, configured to format a preset fourth prompt template based on the generation content of the dialogue topic output by the topic generation module, and generate a fourth prompt;
the character setting generation module being further configured to invoke the pre-trained large language model based on the fourth prompt to output the generation content of the character settings associated with the dialogue topics within the target scenario generated by the pre-trained large language model;
a query generation module, configured to format a preset fifth prompt template based on the generation content of the character settings output by the character setting generation module, and generate a fifth prompt;
the query generation module being further configured to invoke the pre-trained large language model based on the fifth prompt to output the generation content of user queries related to each dialogue topic based on the character settings in the target scenario generated by the pre-trained large language model;
a response generation module, configured to format a preset sixth prompt template based on the generation content of the user queries output by the query generation module, and generate a sixth prompt;
the response generation module is further configured to invoke the pre-trained large language model based on the sixth prompt to output the generation content of the response content corresponding to the user queries generated by the pre-trained large language model;
a dialogue data concatenation module, configured to generate multi-round dialogue data in the target scenario based on the generation content of the user queries and the response content.

The embodiments of this application also disclose an electronic device, which includes: a processor and a memory in communication with the processor; the memory storing computer-executable instructions; the processor executes the computer-executable instructions stored in the memory to implement the methods described in the embodiments of this application.

The embodiments of this application also disclose a computer-readable storage medium storing computer-executable instructions, wherein the computer-executable instructions, when executed by a processor, cause the processor to implement the methods described in the embodiments of this application.

Compared with the prior art, the embodiments of this application offer the following advantages: by obtaining prompt word templates corresponding to various human-computer dialogue elements in the target scenario and generating content dependency relationships, where the human-computer dialogue elements at least include: user queries and response content; and progressively generating content for corresponding human-computer dialogue elements based on the prompt word templates and a pre-trained large language model according to the generation content dependency relationships. Based on the generation content corresponding to the user queries and the response content, multi-round dialogue data in the target scenario is generated, achieving fully automated multi-round dialogue data generation in the target domain without the need for manual annotation, thus reducing the cost of acquiring multi-round dialogue data and improving the efficiency of acquiring such data. Furthermore, by setting prompt word templates and generating content dependency relationships for each human-computer dialogue element, the method of generating dialogue data becomes more flexible, which is conducive to the upgrading and optimization of applications implemented based on dialogue data.

### BRIEF DESCRIPTION OF THE DRAWINGS

FIG. 1 is a flowchart illustrating the steps of an embodiment of the dialogue data generation method disclosed in this application;

FIG. 2 is a schematic diagram illustrating a dialogue data generation process in the dialogue data generation method disclosed in this application;

FIG. 3 is a schematic structural diagram of a dialogue data generation system disclosed in this application;

FIG. 4 is a flowchart illustrating the steps of an embodiment of the model training method disclosed in this application;

FIG. 5 is a flowchart illustrating the steps of an embodiment of the dialogue processing method disclosed in this application;

FIG. 6 is a schematic structural diagram of an exemplary device provided in one embodiment of this application.

### DETAIL DESCRIPTION OF THE EMBODIMENTS

To make the objectives, features, and advantages of this application more apparent and understandable, the following provides a more detailed explanation of this application in conjunction with the accompanying drawings and specific embodiments.

With the expansion of online dialogue applications and the rapid development of various application scenarios, traditional chatbots can no longer meet users' demands for efficient and personalized services. At the same time, the emergence of large language models has introduced new opportunities and challenges for the development of chatbots.

A Large Language Model (LLM) refers to a deep learning model trained on vast amounts of text data, capable of generating natural language text or understanding the meaning of language. LLMs can handle various natural language tasks such as text classification, question answering, and dialogue. While LLMs have strong text comprehension and content generation abilities, the existing large language models (referred to as “pre-trained large language models” in the embodiments of this application) are pre-trained on general-purpose corpora. As a result, their understanding of dialogue content in specific scenarios (such as e-commerce) is not sufficiently precise, and the relevance of the generated responses to specific scenario-based queries needs further improvement. Taking the e-commerce scenario as an example, acquiring dialogue data within this domain is highly challenging. Particularly in the initial stages, where corresponding products are missing, it is difficult to obtain realistic user queries for an e-commerce intelligent assistant. Even if a set of potential user queries is obtained, manually crafting corresponding responses to generate training data is extremely difficult and costly. The shortage of multi-round dialogue data in e-commerce, coupled with the high cost of manual annotation, creates significant challenges in applying LLMs to automatic multi-round dialogues in e-commerce scenarios.

The dialogue data generation method disclosed in the embodiments of this application is designed to automatically generate multi-round dialogue data for different personas in specified scenarios. It eliminates the need for manual annotation, resulting in lower costs and higher efficiency, while also producing rich and comprehensive multi-round dialogue data. In the embodiments of this application, the target scenario includes, but is not limited to, any of the following: e-commerce scenarios, online medical scenarios, or online education scenarios. To facilitate understanding of this approach, the e-commerce scenario is used as an example to illustrate the implementations of the dialogue data generation method, model training method, and dialogue processing method disclosed in this application.

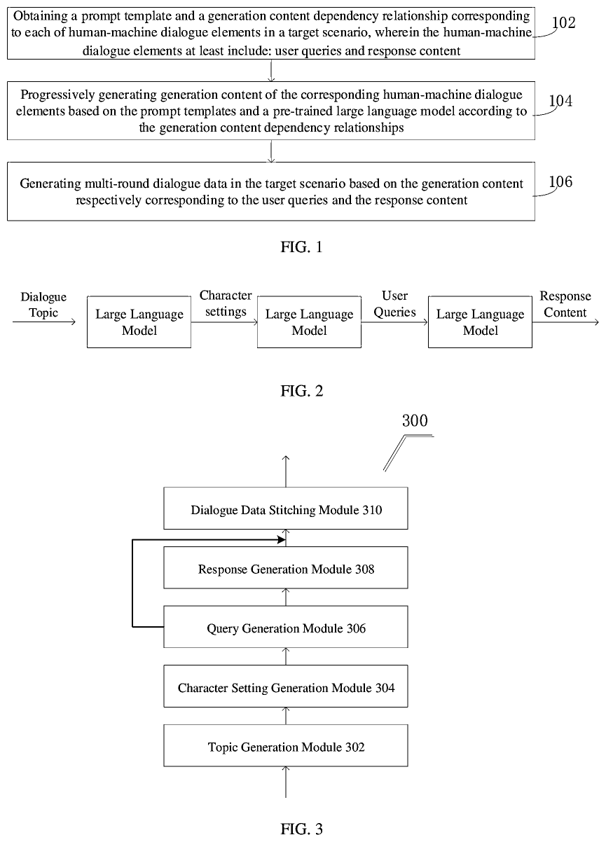

Referring to FIG. 1, in one optional embodiment, the dialogue data generation method disclosed in this application includes the following steps: Step 102 to Step 106.

The specific implementations of each step are introduced below.

S102: obtaining a prompt template and a generation content dependency relationship corresponding to each of human-machine dialogue elements in a target scenario, wherein the human-machine dialogue elements at least include: user queries and response content.

Optionally, the human-machine dialogue elements include at least: user queries and response content.

Optionally, the e-commerce domain can be categorized by the geographic location of user services into: cross-border e-commerce and domestic e-commerce. Different types of e-commerce can define the stages of user involvement in their operations as distinct e-commerce scenarios. For example, e-commerce scenarios include, but are not limited to: purchasing products, using services, querying data, and after-sales inquiries. The dialogue data generation method disclosed in the embodiments of this application does not impose any limitations on the applicable target scenarios.

Taking the e-commerce scenario as an example, by abstracting the related factors in human-machine dialogue within the e-commerce context, human-machine dialogue elements can be identified. Human-machine dialogues in the e-commerce scenario involve various elements, with user queries and response content being the fundamental ones, and these are further related to other elements. For instance, in some optional embodiments, the human-machine dialogue elements may also include one or more of the following: dialogue topics and character settings. Dialogue topics and character settings serve as additional attributes that describe the specific context of the human-machine dialogue, helping to define the precise dialogue scenario. These additional attributes can be determined based on the functional modules of the e-commerce platform or application, or the segmentation of user interaction processes. For example, in some optional embodiments, the human-machine dialogue elements may also include product categories, purchase channels, and more. This embodiment of the application does not limit the specific types or quantity of additional attributes in the human-machine dialogue elements.

The meaning of the human-machine dialogue elements is determined based on the specific e-commerce scenario. Below, examples of the meanings of some key human-machine dialogue elements are provided for illustration.

In the prior art, user queries may refer to queries that e-commerce users input online, while the response content includes replies automatically generated by the e-commerce platform or application in response to these user queries. For example, a user might access the online customer service page via the e-commerce platform's client and input a query. Upon receiving the query, the online customer service page sends it to the e-commerce platform's server for interpretation and generates a corresponding response. The generated response is then sent back to the client, where it is displayed on the customer service page as a reply to the user's query. The dialogue data generation method described in the embodiments of this application, however, utilizes artificial intelligence techniques to generate potential user queries in various e-commerce scenarios, as well as the corresponding response content for these queries.

The dialogue topic is used to describe the various stages in different e-commerce scenarios and the topics that users may engage with. For instance, in a shopping scenario, the dialogue topics may include, but are not limited to, one or more of the following topics related to the returns and exchanges stage: discount policies, return/exchange policies, delivery issues, and warranty policies. In the logistics stage, the dialogue topics may include one or more of the following: delivery times and shipping schedules. The character setting is used to describe the background of the user, their experiences in that e-commerce scenario, and how they may engage with one or more of the above dialogue topics in different stages of the e-commerce process.

The combination of dialogue topics, character settings, and other additional human-machine dialogue attributes across different stages of e-commerce scenarios can form various dialogue contexts. For example, the return/exchange policy at the return/exchange stage in a shopping scenario constitutes one dialogue context, while the delivery time policy at the logistics stage forms another. The response content to user queries varies depending on the specific dialogue context within the e-commerce scenario. In the embodiments of this application, artificial intelligence technology is used to generate user queries and response content for each dialogue context within e-commerce scenarios, creating multi-round user dialogue data that covers the full range of e-commerce scenarios.

In some optional embodiments, a pre-trained large language model can be used to automatically generate specific content for one or more human-machine dialogue elements in various stages of e-commerce scenarios, based on prompts. These elements may include potential dialogue topics that users might encounter, character settings related to each dialogue topic, user queries from different personas in the specified e-commerce scenario, and corresponding response content. For instance, a prompt can be generated for each dialogue element, providing the pre-trained large language model with conditions for content generation, such as the style and constraints for the generation content. The pre-trained large language model is then invoked based on these prompts, and the output text from the model is used as the specific content for the corresponding human-machine dialogue elements.

In the process of generating multi-round dialogue data, the response content is generated based on user queries, and the user queries are generated for different dialogue contexts. These dialogue contexts are further determined by human-machine dialogue elements, such as dialogue topics and character settings, which serve as additional attributes. In other words, there is a dependency relationship between the generation content of the human-machine dialogue elements.

The generation content dependency is used to indicate the dependencies between the generation contents of human-machine dialogue elements. These dependencies include, but are not limited to: whether the generation content of a human-machine dialogue element is dependent, and if so, on which human-machine dialogue element's generation content it depends.

For example, starting with the steps that users might be involved in within various e-commerce scenarios, a pre-trained large language model is used to generate dialogue topics related to those steps within these e-commerce scenarios. Then, using the pre-trained large language model, the model generates character profiles for users who may go through the above steps and dialogue topics. After that, the pre-trained large language model generates a set of logically progressive user queries that these character profiles might propose, closely related to the user. Finally, the pre-trained large language model generates response content for each set ofuser queries. Based on the generation sequence of the human-machine dialogue elements' content, the following dependency relationships can be derived: the response content depends on the generation content of the user's query, the user's query depend on the generation content of the character profiles, and the character profiles depend on the generation content of the dialogue topics.

In the embodiments of this application, the human-machine dialogue elements have a one-to-one correspondence with the prompt templates. Accordingly, the generation content dependency can also be used to indicate the dependency relationships between the prompt templates and the generation content of the human-machine dialogue elements. For example, the generation content dependency describes whether the generation of content based on the current prompt template depends on content generated from other prompt templates, or which prompt template's generation content the current prompt template's generation content depends on.

The prompt template can be input into the system or application that implements the dialogue data generation method disclosed in this application's embodiments in the form of configuration files.

In the embodiments of this application, the generation content dependency of human-machine dialogue elements can be described through the corresponding prompt templates. For example, the prompt template can specify which other human-machine dialogue elements' generation content needs to be input when generating the content of the current human-machine dialogue element.

Optionally, some of the prompt templates include general prompts. These general prompts may include, but are not limited to, factual statement texts when invoking a pre-trained large language model, and descriptive texts for the generation content (such as the style of the generation content).

In some optional embodiments, the generation content dependency is represented by placeholders set in the prompt templates. For example, some of the prompt templates also include placeholders, which are used to describe the dynamically input content required when invoking the pre-trained large language model for content generation based on the current prompt template. The dynamically input content includes content dynamically obtained based on configuration information and/or content dynamically generated by invoking the pre-trained large language model based on other prompt templates.

In the prompt template, the placeholder corresponding to the first human-machine dialogue element indicates that when generating the content for the second human-machine dialogue element, the input conditions depend on the generation content of the first human-machine dialogue element. The second human-machine dialogue element is the one corresponding to the prompt template, while the first and second human-machine dialogue elements are distinct from each other.

In some optional embodiments, taking human-machine dialogue elements such as dialogue topic, character profiles, user queries, and response content as examples: the prompt template corresponding to the character profile uses the placeholder for the dialogue topic to indicate that the input conditions for generating the content of the character profile depend on the generation content of the dialogue topic. Similarly, the prompt template corresponding to user queries uses the placeholder for the character profile to indicate that the input conditions for generating user query content depend on the generation content of the character profile. Likewise, the prompt template corresponding to response content uses the placeholder for user queries to indicate that the input conditions for generating response content depend on the generation content of the user queries.

Accordingly, by parsing the placeholders in the prompt templates, the generation content dependencies between the human-machine dialogue elements can be obtained. The prompt associated with the position of the placeholder is dynamically generated and replaced.

For example, in the prompt template corresponding to human-machine dialogue element b, a placeholder indicates that the generation content of human-machine dialogue element a needs to be input at the corresponding position of the prompt. This means that when generating the content for human-machine dialogue element b, it depends on the generation content of human-machine dialogue element a. Accordingly, the generation content dependency is as follows: the generation content of human-machine dialogue element b depends on the generation content of human-machine dialogue element a.

Optionally, in other prompt templates, the placeholder is also used to describe dynamically configured prompt content.

The prompt templates are determined based on the prompt generation specifications of the pre-trained large language model and the specific content generation requirements.

For example, the content of the prompt template corresponding to the dialogue topic could be: “Could you list 10 potential scenarios a customer may encounter on a cross-border e-commerce website?Please respond in JSON format, using the scenarios as keys and their detailed explanations as values.” This prompt template includes fixed prompt text that describes conditions such as the scene and format for generating the dialogue topic.

Another example is the content of the prompt template corresponding to character profiles, which could be represented as: “Please provide ten informative and representative cases of #GENRE#. Cases presented should be factual and grounded in general knowledge . . . ”. This prompt includes fixed prompt text that describes the requirements and style for generating character profiles, as well as placeholders such as “#GENRE#”. The placeholder is used to describe dynamically generated prompt text for generating character profile descriptions, such as a specific dialogue topic.

Taking human-machine dialogue elements such as dialogue topics, character profiles, user queries, and response content as examples, the content included in the corresponding prompt templates for each human-machine dialogue element is as follows: the prompt template corresponding to the dialogue topic element may include a placeholder to describe the name of the e-commerce scenario that needs to be input, or it may use fixed prompt text to describe the e-commerce scenario for generating the dialogue topic. the prompt template corresponding to the character profile element includes both general prompts and placeholders. The general prompts describe fixed conditions for generating the character profile, such as output style, while the placeholder (for example, represented as #GENRE#) is used to describe the specific descriptive text of the dialogue topic, which will replace the placeholder to generate the prompt. The prompt template corresponding to the user query element includes general prompts and placeholders. The general prompts describe fixed conditions for generating user queries, such as output style, and the placeholder (for example, represented as #SETTINGS #) is used to describe the specific descriptive text of the character profile, which will replace the placeholder to generate the prompt. The prompt template corresponding to the response content element includes general prompts and placeholders. The general prompts describe fixed conditions for generating response content, such as output style, and the placeholder (for example, represented as #MULTI_ROUND_OF_CONVERSATIONS #) is used to describe the specific descriptive text of the user queries, which will replace the placeholder to generate the prompt.

In the embodiments of this application, by decomposing the human-machine dialogue scenario into human-machine dialogue elements such as user queries, response content, dialogue topics, and character profiles, and assigning a corresponding prompt template to each element, the input conditions for generating the content of each element are described using placeholders within the prompt templates. This approach enables flexible configuration of dialogue scenarios, allowing the dialogue data generation method disclosed in the embodiments of this application to efficiently and cost-effectively generate multi-round dialogue data for different e-commerce scenarios. As a result, it provides strong support for the version iteration and optimization of human-machine dialogue products.

S104: progressively generating generation content of the corresponding human-machine dialogue elements based on the prompt template and a pre-trained large language model according to the generation content dependency relationships.

After obtaining the prompt templates corresponding to each human-machine dialogue element and the generation content dependency for each element, the generation content for each human-machine dialogue element is progressively generated based on the corresponding prompt templates and the pre-trained large language model, step by step.

In some optional embodiments, progressively generating the content of the corresponding human-machine dialogue elements based on the prompt templates and the pre-trained large language model according to the generation content dependency includes: determining the first prompt template and the second prompt template based on the generation content dependency; generating the content of the corresponding human-machine dialogue elements based on the first prompt template and the pre-trained large language model; and progressively generating the content of the corresponding human-machine dialogue elements based on the second prompt template, the previously generated target content, and the pre-trained large language model, according to the generation content dependency.

As previously mentioned, among the human-machine dialogue elements in e-commerce scenarios, some elements' generation content does not depend on the dynamically generation content (such as descriptive text) of other elements, while others require such dependencies. Therefore, the content generation operations for the corresponding human-machine dialogue elements need to be executed progressively in sequence according to the generation content dependency.

In some optional embodiments, the prompt templates corresponding to human-machine dialogue elements whose generation content does not depend on other generation content are referred to as “first prompt templates.” The prompt templates corresponding to human-machine dialogue elements whose generation content depends on other generation content are referred to as “second prompt templates.” First, the generation content for the human-machine dialogue elements corresponding to the first prompt templates is generated based on the first prompt templates and the pre-trained large language model. Then, according to the generation content dependency, the generation content for each human-machine dialogue element corresponding to the second prompt templates is sequentially generated based on the second prompt templates, the dependent generation content, and the pre-trained large language model.

In some embodiments of this application, generating the content of the corresponding human-machine dialogue elements based on the first prompt templates and the pre-trained large language model includes: treating each first prompt template as the current prompt template and executing the following first content generation operation, which includes sub-step A1 and sub-step A2.

Sub-SA1: Based on the current prompt template, generate the first current prompt.

Sub-SA2: Based on the first current prompt, invoke the pre-trained large language model to generate the content of the corresponding human-machine dialogue element.

When the preset prompt templates include multiple first prompt templates, there is no restriction on the order in which content is generated based on the first prompt templates. For example, a random order can be used to traverse the first prompt templates. During the traversal of the first prompt templates, the currently traversed first prompt template is treated as the current prompt template. Then, based on the current prompt template, a prompt is generated, referred to in this embodiment as the “first current prompt.” Subsequently, the pre-trained large language model is invoked based on the first current prompt to generate the content corresponding to the human-machine dialogue element for that first current prompt.

Taking the prompt template for the dialogue topic as an example, the prompt for generating the dialogue topic can be initialized directly based on this template. Then, the initialized prompt is used to invoke the pre-trained large language model, which generates the content for the dialogue topic. In other optional embodiments, when the first prompt template contains placeholders, the specific content text described by the placeholders is first obtained. This specific content text is then used to replace the corresponding placeholders in the first prompt template, generating the prompt. After replacing the placeholders, the pre-trained large language model is invoked based on the updated prompt to generate the corresponding content.

In some optional embodiments, progressively generating the content of the corresponding human-machine dialogue elements based on the second prompt templates, the previously generated target content, and the pre-trained large language model according to the generation content dependency includes: determining the generation sequence for the content of the human-machine dialogue elements corresponding to the second prompt templates based on the generation content dependency; and sequentially executing the second content generation operations in order, from first to last, according to the determined generation sequence.

Taking the character settings, user queries, and response content, as described earlier in the e-commerce scenario, as an example of human-computer dialogue elements, the generation content dependency indicates that generating response content requires input of user queries, generating user queries requires input of character settings, and generating character settings requires input of dialogue topic and other relevant information. Therefore, following the aforementioned content dependency, character settings must be generated first, followed by using the character settings as part of the input to generate user queries, and finally, using the user queries as part of the input to generate response content.

After determining a generation order of the human-computer dialogue elements, the generation operations for the current content are executed sequentially according to the specified order. In the embodiments of this application, this process is referred to as the “second content generation operations.”

Optionally, the second content generation operations include sub-SB1 to B3.

Sub-SB1: based on the content dependency, acquire the previously generated content that the current human-computer dialogue element's content generation depends on, and treat it as the target generation content.

Sub-SB2: based on the target generation content, format the second prompt template corresponding to the current human-computer dialogue element to generate the second current prompt.

Sub-SB3: based on the second current prompt, invoke the pre-trained large language model to generate the content for the current human-computer dialogue element.

When generating the content for each human-computer dialogue element, the generation content of the dialogue element on which the current element depends is used to replace the corresponding placeholders in the second prompt template of the current human-computer dialogue element. This formats the second prompt template into a usable prompt, referred to in this embodiment as the “second current prompt.” Subsequently, based on the second current prompt, the pre-trained large language model is invoked to generate the content for the current human-computer dialogue element.

Taking the determined generation order as an example—first generating the character settings, followed by generating the user queries, and finally generating the response content—the following will illustrate, with reference to FIG. 2, the generation scheme for the content of these human-computer dialogue elements.

Firstly, the second content generation operations corresponding to the character settings are executed to generate the content for the character settings.

For the character settings as a human-computer dialogue element, its corresponding prompt template includes a placeholder for the dialogue topic (e.g., #GENRE#). By replacing the placeholder #GENRE# with the dialogue topic content generated using the method described earlier, the second current prompt is generated. Then, based on this second current prompt, the pre-trained large language model is invoked, and the generation content is used as the character settings content, produced according to the dialogue topic and other input conditions in the prompt.

The second content generation operations corresponding to the user queries are executed to generate the content for the user queries.

For the user queries as a human-computer dialogue element, its corresponding prompt template includes a placeholder for the character settings (e.g., #SETTINGS #). By replacing the placeholder #SETTINGS # with the character settings content generated using the method described earlier, the second current prompt is generated. Then, based on this second current prompt, the pre-trained large language model is invoked, and the generation content is used as the user query content, produced according to the character settings and other input conditions in the prompt.

In some optional embodiments, the prompt template corresponding to the user queries includes a rule-based prompt. This rule-based prompt is used to instruct the pre-trained large language model to generate user queries according to a first rule, wherein the first rule includes: the generated sets of user queries must be correlated and have a logical progression, and incorporate at least N instances of contextual information, where N is a natural number greater than 1.

For example, the prompt template corresponding to the user queries as a human-computer dialogue element may also include a fixed prompt. This fixed prompt is used to describe the rules and style for generating user queries. The rules described in the fixed prompt for generating user queries may include, but are not limited to, one or more of the following: the first rule: generate multiple sets of user queries that are correlated and have a logical progression, using the dialogue topic and information from the context to enable multiple rounds of dialogue with the assistant; the second rule: generate queries that incorporate specific contextual information at least twice, formulating queries based on the given context to describe the situation of the questioner. Preferably, positive context is used, and the corresponding contextual queries should stem from the real situation of the questioner and be highly relevant to the questioner's actual circumstances.

Finally, the second content generation operations corresponding to the response content are executed to generate the content for the response.

For the response content as a human-computer dialogue element, its corresponding prompt template includes a placeholder for user queries (e.g., #MULTI_ROUND_OF_CONVERSATIONS #). By replacing the placeholder #MULTI_ROUND_OF_CONVERSATIONS # with the user query content generated using the method described earlier, the second current prompt is generated. Then, based on this second current prompt, the pre-trained large language model is invoked, and the generation content is used as the response content based on the user queries in the prompt.

In some optional embodiments, the prompt template corresponding to the response content includes an instruction prompt. This instruction prompt is used to instruct the pre-trained large language model to generate the response content based on the prior dialogue, specifically responding to the final user query in the previous round of the conversation.

For example, the prompt template corresponding to the response content as a human-computer dialogue element may also include a fixed prompt. This fixed prompt is used to describe the instructions, conditions, and style for generating the response content. For instance, the conditions described in the fixed prompt may include prior dialogue data, and the instructions may include, but are not limited to: “Please respond to the last user message on behalf of the assistant in a suitably concise manner.” Additionally, the fixed prompt may describe conditions such as: considering the user's specific situation and providing the most relevant information they are likely to expect, while avoiding generic responses.

By setting the prompt templates according to the dependency relationships between the content of the human-computer dialogue elements and sequentially executing the corresponding content generation operations based on the dependency order, the generation content of the previous dialogue element is used as the input condition for the next dialogue element. This process continues until the content for the final dialogue element, the response content, is generated, thereby enabling fully automated multi-round dialogue data generation.

S106: generating multi-round dialogue data in the target scenario based on the generation content respectively corresponding to the user queries and the response content.

After executing the aforementioned steps, multiple sets of user queries can be obtained, with each round of queries within a set having relevance and logical progression. Additionally, multiple sets of response content can be generated, with each set corresponding to a set of user queries. As described earlier, each round of queries within a set of user queries generated from the prompt maintains relevance and logical progression. Correspondingly, the set of response content generated for each set of user queries also preserves relevance and logical progression between rounds, as determined by the working principles of the pre-trained large language model. Based on a set of user queries and the corresponding response content, a set of multi-round dialogue data can be generated.

In some optional embodiments, the user queries have a logical progression, and the response content corresponds to the user queries. Based on the generation content corresponding to the user queries and the response content, multi-round dialogue data for the target scenario is generated. This includes: for each set of user queries, constructing an ordered combination of multi-round question-answer pairs based on the logical progression of the user queries and the corresponding response content. Using this ordered combination, the multi-round dialogue data for the target scenario is generated. Each question-answer pair consists of a user query and its corresponding response content.

For each set of user queries, the corresponding round of user queries and the corresponding round of response content from the associated set of responses are combined to form a question-answer pair. In this way, a set of question-answer pairs can be obtained for each set of user queries. Denoting a set of user queries as {u₁, u₂, . . . , uₙ} and a set of response content as {a₁, a₂, . . . , aₙ}, the n rounds of user queries u₁, u₂, . . . , uₙ within each set exhibit relevance and logical progression. Similarly, the n rounds of response content a₁, a₂, . . . , aₙ, generated in response to the set of user queries, also maintain logical relevance and progression. Each round of user query u₁ and its corresponding round of response content aᵢ can be combined into a question-answer pair (u₁, a₁). Thus, n rounds of question-answer pairs are formed, where 1≤i≤n, and n is aₙ integer greater than 2. These n rounds of question-answer pairs, ordered according to their logical progression, result in a set of multi-round dialogue data. For example, a set of multi-round dialogue data can be represented as {(u₁, a₁), (u₂, a₂), . . . , (uₙ, uₙ)}.

Following the aforementioned method, for each set of user queries, a set of multi-round dialogue data composed of ordered question-answer pairs can be obtained.

From the method of generating multi-round dialogue data, it is evident that the semantic consistency of the dialogue context and the coherence of the conversation are preserved throughout the multi-round dialogue data.

In summary, the dialogue data generation method disclosed in this application involves acquiring the prompt templates and content dependency relationships corresponding to the human-computer dialogue elements in the target scenario. These dialogue elements include at least user queries and response content. By progressively generating the content of the respective dialogue elements based on the dependency relationships, using the prompt templates and the pre-trained large language model, the multi-round dialogue data for the target scenario is generated. This process allows for fully automated generation of multi-round dialogue data in the target domain, eliminating the need for manual annotation, reducing the cost of obtaining multi-round dialogue data, and enhancing the efficiency of data acquisition. Moreover, by controlling the pre-trained large language model with preset prompts and generating potential values for human-computer dialogue elements in the target domain (e.g., e-commerce), different potential dialogue scenarios can be generated based on varying values of the dialogue elements, further expanding the coverage of the acquired dialogue data.

Furthermore, by setting prompt templates for each human-computer dialogue element and introducing dynamically generated input data through placeholders in the prompt templates, the method for generating dialogue data becomes more flexible. For instance, it allows for flexible control over the topic categories and response styles in the dialogue data, which facilitates the upgrading and optimization of applications that rely on the dialogue data. By describing the content dependency relationships between different dialogue elements through placeholders in the prompt templates, the dialogue data generation strategy can be adjusted flexibly. This approach makes it easier to generate comprehensive multi-round dialogue data that aligns with real-world scenarios.

On the other hand, in this application's embodiment, each human-computer dialogue element is assigned a separate prompt template, and by introducing the dependency relationships for the generation content of the dialogue elements into the prompt templates, a pipeline approach is used to invoke these templates. This simplifies the design of the prompts and breaks down the process of generating multi-round dialogue data into several independent, sequential modules, enhancing the stability of each module. As a result, the overall stability of the multi-round dialogue data generation process is improved, which helps ensure the quality of the generated dialogue data.

Based on the aforementioned embodiments, this application also discloses a dialogue data generation system designed to implement the above dialogue data generation method, in order to generate multi-round dialogue data for a target scenario.

Referring to FIG. 3, the dialogue data generation system 300 includes: a topic generation module 302, a character setting generation module 304, a query generation module 306, a response generation module 308, and a dialogue data stitching module 310. The following sections describe the specific implementations of each system component and their data interaction relationships.

The topic generation module 302 is used to generate a third prompt based on a preset third prompt template and, using this third prompt, invoke the pre-trained large language model. The module outputs the generation content for multiple dialogue topics within the target scenario, as produced by the pre-trained large language model.

The character setting generation module 304 is used to format the preset fourth prompt template based on the generation content of the dialogue topics output by the topic generation module 302, thereby generating the fourth prompt.

The character setting generation module 304 is also used to invoke the pre-trained large language model based on the fourth prompt, and output the generation content for character settings associated with the specified dialogue topics in the target scenario, as produced by the pre-trained large language model.

The query generation module 306 is used to format the preset fifth prompt template based on the generation content of the character settings output by the character setting generation module 304, thereby generating the fifth prompt.

The query generation module 306 is also used to invoke the pre-trained large language model based on the fifth prompt and output the generation content for user queries. These queries are associated with the character settings for each of the dialogue topics within the target scenario, as generated by the pre-trained large language model;
the response generation module 308 is used to format the preset sixth prompt template based on the generation content of the user queries output by the query generation module 306, thereby generating the sixth prompt;
the response generation module 308 is also used to invoke the pre-trained large language model based on the sixth prompt, and output the generation content for the responses corresponding to the user queries, as generated by the pre-trained large language model.

The dialogue data stitching module 310 is used to generate multi-round dialogue data for the target scenario based on the generation content of the user queries and the response content.

The specific implementation of generating multi-round dialogue data for the target scenario based on the generation content of the user queries and response content can be found in the descriptions of the previous embodiments. This will not be repeated here.

The preset fourth prompt template, preset fifth prompt template, and preset sixth prompt template include placeholders. These placeholders are used to represent the content dependencies required when generating content based on the respective prompt template.

Optionally, the placeholders in the preset fourth prompt template represent that the input conditions required to generate the character settings content include the generation content of the dialogue topics. The placeholders in the preset fifth prompt template represent that the input conditions for generating the user query content include the generation content of the character settings. Similarly, the placeholders in the preset sixth prompt template represent that the input conditions for generating the response content include the generation content of the user queries.

Optionally, the fifth prompt template includes a rule-based prompt. This rule-based prompt is used to instruct the pre-trained large language model to generate user queries according to a first rule. The first rule includes: the generated sets of user queries must be relevant, have a logical progression, and incorporate contextual information at least N times, where N is a natural number greater than 1.

Optionally, the sixth prompt template includes aₙ instruction prompt. This instruction prompt is used to direct the pre-trained large language model to generate the response content based on the previous dialogue, specifically responding to the last round of user queries in the prior conversation.

The structure, content, and method of obtaining the preset third prompt template can be referenced in the previous embodiments, where the prompt template corresponding to the dialogue topic as a human-computer dialogue element is described. These details are not reiterated in this embodiment.

The structure, content, and method of obtaining the preset fourth, fifth, and sixth prompt templates can be referenced in the previous embodiments, where they correspond to the human-computer dialogue elements of character settings, user queries, and response content, respectively. These details are not reiterated in this embodiment.

In summary, the dialogue data generation system disclosed in this application utilizes preset prompt templates corresponding to the topic generation module, character setting generation module, query generation module, and response generation module, respectively. By sequentially invoking each module and formatting the current module's prompt template based on the generation content output from the previous module, the input content to each module is dynamically updated. This enables the current module to generate output based on the content provided by the previous module under the given input conditions, allowing for fully automated generation of multi-round dialogue data for potential users and topics in specific target scenarios within the target domain. This eliminates the need for manual annotation, reduces the cost of acquiring multi-round dialogue data, and improves the efficiency of data acquisition. Additionally, by using preset prompts to control the pre-trained large language model and generate potential values for human-computer dialogue elements in the target domain, various potential dialogue scenarios can be generated based on different values of the dialogue elements. This further facilitates the generation of user queries and response content for each dialogue scenario, thereby expanding the coverage of the acquired dialogue data.

Furthermore, by setting prompt templates for each human-computer dialogue element and introducing dynamically generated input data through placeholders in the prompt templates, the dialogue data generation process becomes more flexible. For example, it allows for flexible control over the topic categories, response styles, and other aspects of the dialogue data. This flexibility is beneficial for upgrading and optimizing applications that rely on the dialogue data.

On the other hand, by using a pipeline approach to invoke the prompt templates, the design of the prompts is simplified. This breaks down the multi-round dialogue data generation process into multiple independent, sequential modules, enhancing the stability of each module. As a result, the overall stability of the multi-round dialogue data generation process is improved, which helps ensure the quality of the generated dialogue data.

Based on the above embodiments, this application also discloses a model training method. This method involves fine-tuning a pre-trained large language model using the multi-round dialogue data generated by the aforementioned dialogue data generation method. The result is a dialogue content generation model with enhanced understanding of dialogues in the target domain. This model will be able to generate more accurate and context-appropriate responses to user queries in specific target scenarios.

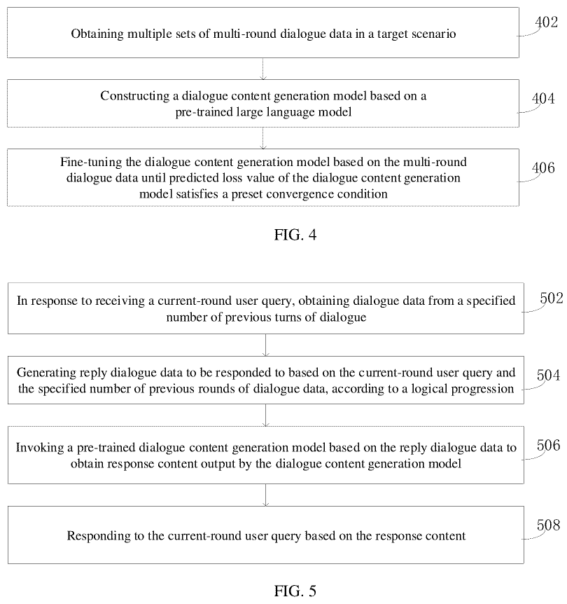

Referring to FIG. 4, the model training method includes S402 to 406.

S402: obtaining multiple sets of multi-round dialogue data in a target scenario.

Each set of multi-round dialogue data includes multiple rounds of user queries and response content, arranged in a logical progression.

For example, the multi-round dialogue data includes combinations of question-answer pairs arranged in a logical progression. Each question-answer pair consists of a user query and the corresponding response content for that query.

In some optional embodiments, obtaining several sets of multi-round dialogue data from the target scenario includes: acquiring prompt templates and content dependency relationships corresponding to the human-computer dialogue elements in the target scenario. These dialogue elements include user queries and response content. The content of the respective dialogue elements is progressively generated based on the content dependency relationships, using the prompt templates and a pre-trained large language model. Based on the generation content for the user queries and the response content, multi-round dialogue data for the target scenario is generated.

The specific implementation steps for obtaining several sets of multi-round dialogue data in the target scenario can be referenced in the relevant descriptions from the previous embodiments. These details are not reiterated here.

S404: constructing a dialogue content generation model based on a pre-trained large language model.

In some optional embodiments, a loss function can be added to the end of the pre-trained large language model to construct the dialogue content generation model. The core network structure of the dialogue content generation model is the pre-trained large language model.

S406: fine-tuning the dialogue content generation model based on the multi-round dialogue data until predicted loss value of the dialogue content generation model satisfies a preset convergence condition.

The predicted loss value is calculated based on the single-round dialogue prediction loss for each set of multi-round dialogue data. The single-round dialogue prediction loss is the negative log-likelihood average obtained by modeling the predicted response content generated by the dialogue content generation model in response to the user queries from each round of dialogue data.

For example, the predicted loss value for a set of multi-round dialogue data can be calculated using the following formula:

$${L}_{k} = \frac{1}{T} {\sum }_{t = 1}^{T} N L L ( {a}_{t} \vert {u}_{1} , {a}_{1} , … , {u}_{t - 1} , {a}_{t - 1} , {u}_{t} ) ;$$

wherein, Lₖ represents the predicted loss value for the k-th set of multi-round dialogue data. Lₖ represents the single-round dialogue prediction loss for the t-th round of dialogue data in the k-th set of multi-round dialogue data. NLL(aₜ|u₁, a₁, . . . , uₜ₋₁, aₜ₋₁, uₜ) denotes the single-round dialogue prediction loss for the t-th round of dialogue in the k-th set of multi-round dialogue data, i.e., the negative log-likelihood of aₜ conditioned on {u₁, a₁, . . . , uₜ₋₁, aₜ₋₁, uₜ}. aₜ represents the response content label corresponding to the user query uₜ in the t-th round of the k-th set of multi-round dialogue data.

In some optional embodiments, fine-tuning the dialogue content generation model based on the multi-round dialogue data, until the model's predicted loss value meets the preset convergence conditions, includes the following prediction operations for each set of multi-round dialogue data to obtain the corresponding predicted loss value: for each round of dialogue, constructing the corresponding training data by using the user query from the current round and the prior dialogue data from that round; inputting the training data for each dialogue round into the dialogue content generation model, and obtaining the predicted response content corresponding to the final user query in the current input training data; calculating the negative log-likelihood of the predicted response content under the given training data conditions, treating this as the single-round dialogue prediction loss. Compute the average of the single-round prediction losses across all rounds of the multi-round dialogue data, treating this average as the predicted loss value corresponding to the multi-round dialogue data. Based on the predicted loss values of each set of multi-round dialogue data, calculate the overall predicted loss value for the dialogue content generation model; Optimizing the parameters of the dialogue content generation model to minimize the predicted loss value, continuing this process until the predicted loss value meets the preset convergence conditions.

When training the dialogue content generation model, each set of multi-round dialogue data can be further decomposed into individual rounds of dialogue data, consisting of the user query and its preceding dialogue context, forming the data awaiting a response. Based on this data, training data for each round of dialogue is generated. The training data is then input into the dialogue content generation model to obtain the predicted response value corresponding to the final user query in the current input training data. The single-round dialogue prediction loss is calculated based on this predicted response value.

Taking a set of multi-round dialogue data that includes T round of dialogue as an example, where x={u₁, a₁, . . . , u_{T}, a_{T}}, u₁ represents the user query in the i-th round of dialogue data, and u₁ represents the response content in the i-th round of dialogue data. During the training of the dialogue content generation model, for each round of dialogue data and its preceding dialogue context, a set of dialogue data to be responded to is constructed. For example, for the t-th round of dialogue data, the previous t-1 round of dialogue data and the t-th round user query are concatenated to form the dialogue data to be responded to for the t-th round, such as {u₁, a₁, . . . , uₜ₋₁, aₜ₋₁, uₜ}. Then, this dialogue data to be responded to, {u₁, a₁, . . . , uₜ₋₁, aₜ₋₁, uₜ}, is used as training data, and the response content aₜ, corresponding to the user query uₜ in the t-th round, is used as the label for the training data. This is fed into the dialogue content generation model to obtaining the predicted response content âₜ corresponding to the user query uₜ in the t-th round of dialogue data. The input text {u₁, a₁, . . . , uₜ₋₁, aₜ₋₁, uₜ} is encoded into an embedding representation through a multi-layer network structure, and eventually, it is mapped into a probability distribution over the vocabulary through a linear network layer. Furthermore, the negative log-likelihood NLL(aₜ|u₁, a₁, . . . , uₜ₋₁, aₜ₋₁, uₜ) is calculated from the probability distribution over the vocabulary, where {u₁, a₁, . . . , uₜ₋₁, aₜ₋₁, uₜ} serves as the condition, and the predicted response content âₜ is compared to the label aₜ. This serves as the single-round dialogue prediction loss for the t-th round of dialogue data.

Following the above method, after iteratively obtaining the prediction results of the dialogue content generation model for each of the T round of dialogue data and calculating the single-round dialogue prediction loss for each of these T rounds, the average of the single-round prediction losses is computed to yield the predicted loss value corresponding to a set of multi-round dialogue data x. Optionally, the average of the predicted loss values for all sets of multi-round dialogue data can be used as the overall predicted loss value for the dialogue content generation model.

With the goal of minimizing the predicted loss value, the model parameters of the dialogue content generation model are optimized through iterative training. This process continues until the predicted loss value meets the preset convergence conditions, at which point the training is completed. The resulting dialogue content generation model can then be deployed and applied in real-world scenarios.

By using the negative log-likelihood loss between the predicted response content (i.e., the response prediction value) generated by the model based on the input user query, and the actual response content from the training data (i.e., the response label), the model is constrained to optimize towards the response content and style in the training data. Ultimately, this approach ensures that the model converges towards the distribution of the training data while maintaining generalization capabilities.

In summary, the model training method disclosed in this application involves fine-tuning a dialogue content generation model built on a pre-trained large language model using several sets of multi-round dialogue data from a target scenario. The fine-tuning process continues until the predicted loss value of the model meets the preset convergence conditions. During the training process, the predicted loss value is configured to be calculated based on the single-round dialogue prediction loss for each set of multi-round dialogue data. This prediction loss is determined by modeling the average negative log-likelihood of the response content prediction value generated by the dialogue content generation model for each user query in the dialogue rounds. When conducting supervised fine-tuning of the dialogue content generation model based on pre-trained large language models using generated multi-round free dialogue data, the application of the negative log-likelihood loss function focuses solely on modeling the response content. This reduces the impact of noise in user queries on language modeling, thereby improving the quality of the response content generated by the trained dialogue content generation model.

In this application embodiment, the dialogue content generation model is adapted from a general-purpose model to a target domain by utilizing domain-specific corpora, thereby enhancing the model's understanding of domain-specific knowledge, such as in the e-commerce field. By applying supervised fine-tuning with dialogue-structured corpora, the model is upgraded from basic text generation to multi-round dialogue capabilities. As a result, the dialogue content generation model acquires the ability to engage in free-form conversations and provide specialized services required by the target intelligent assistant in the designated domain.

Based on the above embodiments, this application also discloses a dialogue processing method. This method uses the dialogue content generation model, trained as described in previous embodiments, to predict responses to user queries in a target scenario. By generating response content tailored to the user query and providing accurate replies, this method enhances the precision of responses to user queries, further improving the multi-round user experience.

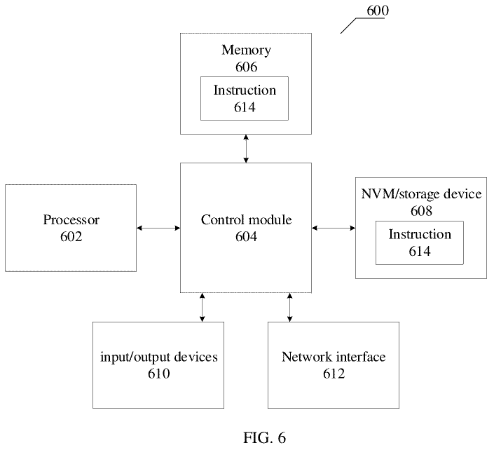

Referring to FIG. 5, the dialogue processing method includes the steps from 502 to 508.

S502, in response to receiving a current-round user query, obtaining dialogue data from a specified number of previous rounds of dialogue.

As an example of implementing the dialogue processing method disclosed in this application within an e-commerce intelligent assistant, the user can interact with the assistant through the user client interface. For instance, the user may input any query related to various aspects of an e-commerce scenario via the client page. In this case, the e-commerce intelligent assistant retrieves the user's input from the client page and treats it as the current round of user queries.

It should be noted that the e-commerce intelligent assistant can determine and retrieve the context of the current conversation based on preset rules. For example, the assistant can treat dialogue data exchanged with the user within a preset time frame (such as 1 hour or longer) as the contextual data for the current round of user queries.

The specified number of previous rounds can be determined based on the number of dialogue rounds in the contextual data. For example, a threshold for the number of rounds can be set according to the input data format requirements of the dialogue content generation model. If the number of dialogue rounds in the contextual data for the current round of user queries is greater than or equal to the threshold, the specified number of previous rounds is set to this threshold. If the number of rounds in the contextual data is less than the threshold, the specified number of previous rounds is set to the actual number of rounds in the contextual data.

S504: generating reply dialogue data to be responded to based on the current-round user query and the specified number of previous rounds of dialogue data, according to a logical progression.

In some optional embodiments, the specified number of previous rounds of dialogue data includes: a combination of user queries from each round and the corresponding response content for each user query. For example, the dialogue data from the previous n rounds can be represented as u₁, a₁, . . . , uₙ, aₙ, where u₁ and uₙ represent the user queries from the 1st and n-th round respectively, and a₁ and aₙ represent the response content from the 1st and n-th rounds respectively.

In some optional embodiments, based on the current round of user queries and the specified number of previous rounds of dialogue data, dialogue data to be responded to is generated according to a logical progression. This includes: performing a format conversion on the specified number of previous rounds of dialogue data according to the logical progression, resulting in a sequence of question-answer pairs composed of user queries and corresponding response content; appending the current round of user queries to the end of the sequence to generate the dialogue data to be responded to. For example, if the current round of user queries is represented as uₙ₊₁, and the previous n rounds of dialogue data are represented as u₁, a₁, . . . , uₙ, aₙ, the generated dialogue data to be responded to can be represented as u₁, a₁, . . . , uₙ, aₙ.

The logical progression can be determined based on the correspondence between the user query and the relevant response content, as well as the chronological order in which the data was generated.

S506: invoking a pre-trained dialogue content generation model based on the reply dialogue data to obtain response content output by the dialogue content generation model.

In some optional embodiments, the dialogue content generation model is pre-trained using the model training method disclosed in previous embodiments. The specific training method for the dialogue content generation model is not repeated in this embodiment.

In some optional embodiments, invoking the pre-trained dialogue content generation model based on the dialogue data awaiting a response to obtain the model's output response content includes the following steps: formatting a preset prompt template based on the dialogue data awaiting a response, generating a prompt. using the generated prompt to invoke the dialogue content generation model, which then outputs the response content.

The content and format of the prompt template, as well as the design method, can refer to the prompt template associated with the response content element in previous embodiments. These details are not repeated here. For example, the preset prompt template may include instructions, conditions, or style descriptions for generating response content. An example of a fixed prompt might include instructions such as: “Please respond to the last user query on behalf of the assistant in a concise and appropriate manner.”

The specific implementation of the dialogue content generation model generating corresponding response content based on the input multi-round dialogue data can be referenced in existing techniques, and thus will not be elaborated upon here.

S508: responding to the current-round user query based on the response content.

In some optional embodiments, the dialogue content generation model may output multiple response options. The e-commerce intelligent assistant can select one of these responses based on a preset strategy to reply to the current round of user queries. Additionally, the e-commerce assistant can respond to the user's query through the user client interface.

In summary, the dialogue processing method disclosed in this application involves, after receiving the current round of user queries, further retrieving the specified number of previous dialogue rounds related to the current query. generating reply dialogue data to be responded to based on the current-round user query and the specified number of previous rounds of dialogue data, according to a logical progression. By predicting the response content using multi-round dialogue data, this approach improves the relevance and accuracy of the responses to user queries. Furthermore, by invoking a pre-trained dialogue content generation model based on the dialogue data awaiting a response, and replying to the current round of user queries based on the model's output, the system benefits from the strong language understanding capabilities of the pre-trained large language model. This model is trained on extensive multi-round dialogue data in the target domain (e.g., e-commerce), and it learns specific user experience scenarios within that domain, resulting in higher-quality responses tailored to the target scenario.

Upon evaluation, constructing multi-round dialogue data using the dialogue data generation method proposed in this application, and fine-tuning the large language model to obtain the dialogue content generation model, resulted in a 5.91% improvement in response accuracy on the multi-round dialogue leaderboard MT-Bench (a mainstream large language model evaluation ranking in existing technology). Additionally, it brought a 9.97% performance improvement in paired testing on the instruction-following leaderboard Alpaca Eval.

It should be noted that the use of user data in this application embodiment may be involved. In practical applications, user-specific personal data may be used within the scope permitted by applicable laws and regulations of the relevant country (e.g., with explicit user consent and proper user notification). Such data use must comply with the applicable legal requirements described in this solution.

It should be noted that, for the method embodiments, they are described as a series of actions for simplicity. However, those skilled in the art will understand that the embodiments of this application are not limited by the order of the actions described, as certain steps may be performed in a different sequence or simultaneously according to the embodiments. Furthermore, it should be understood by those skilled in the art that the embodiments described in the specification are preferred embodiments, and the actions involved are not necessarily required for the embodiments of this application.

Based on the above embodiments, this embodiment further provides a dialogue data generation device, which includes:
Prompt Template and Content Dependency Relationship Acquisition Module: this module is designed to obtaining prompt templates and a generation content dependency relationship corresponding to each of human-machine dialogue elements in a target scenario, wherein the human-machine dialogue elements at least include: user queries and response content;
Content Generation Module: this module is responsible for progressively generating the content of the corresponding human-computer dialogue elements based on the content dependency relationships. It does so by using the prompt templates and a pre-trained large language model for each dialogue element;
Multi-round Dialogue Data Acquisition Module: this module is designed to generate multi-round dialogue data for the target scenario based on the generation content corresponding to the user queries and response content.

In some optional embodiments, the Content Generation Module is further configured to:
determining the first prompt template and the second prompt template in the prompt templates based on the content dependency relationships;
generating the corresponding content of the human-computer dialogue element based on the first prompt template and the pre-trained large language model;
progressively generate the corresponding content of the human-computer dialogue element based on the second prompt template, the previously generated target content, and the pre-trained large language model, following the content dependency relationships.

In some optional embodiments, generating the corresponding content of the human-computer dialogue element based on the first prompt template and the pre-trained large language model includes the following steps:
treating the first prompt template as the current prompt template, and perform the following first content generation operation:
generating the first current prompt based on the current prompt template;
invoking the pre-trained large language model using the first current prompt to generating the corresponding content for the human-computer dialogue element.

In some optional embodiments, progressively generating the corresponding content of the human-computer dialogue element based on the second prompt template, the previously generated target content, and the pre-trained large language model, according to the content dependency relationships, includes:
based on the content dependency relationships, determining the generation sequence for the content of the human-computer dialogue element corresponding to the second prompt template;
executing the second content generation operations sequentially according to the determined generation order, where the second content generation operations include:
based on the content dependency relationships, retrieve the previously generated content that the current human-computer dialogue element depends on, treating it as the target content;
based on the target content, format the second prompt template corresponding to the current human-computer dialogue element to generate the second current prompt;
invoking the pre-trained large language model using the second current prompt to generate the content for the current human-computer dialogue element.

In some optional embodiments, the content dependency relationships are represented by placeholders set within the prompt templates.

In some optional embodiments, the prompt template uses a placeholder corresponding to the first human-computer dialogue element to indicate that the input conditions for generating the content of the second human-computer dialogue element depend on the generation content of the first human-computer dialogue element. Here, the second human-computer dialogue element is the dialogue element corresponding to the prompt template.

In some optional embodiments, the prompt template corresponding to the user queries includes a rule-based prompt. This rule-based prompt instructs the pre-trained large language model to generate user queries according to a first rule. The first rule specifies that the generated sets of user queries must be relevant, have a logical progression, and incorporate contextual information at least N times, where N is a natural number greater than 1.

In some optional embodiments, the prompt template corresponding to the response content includes an instruction prompt. This instruction prompt is used to direct the pre-trained large language model to generate the response content based on the prior dialogue, specifically responding to the last round of user queries in the dialogue context.

In some optional embodiments, the user queries have a logical progression, and the response content corresponds to the user queries. The Multi-round Dialogue Data Acquisition Module is further configured to:
for each set of user queries, construct an ordered combination of multi-round question-answer pairs based on the logical progression of the user queries and their corresponding response content. Using this ordered combination, generate the multi-round dialogue data for the target scenario.

In summary, the dialogue data generation apparatus disclosed in one embodiment of this application operates by obtaining prompt templates and a generation content dependency relationship corresponding to each human-machine dialogue elements in a target scenario, wherein the human-machine dialogue elements at least include: user queries and response content. Based on the content dependency relationships, the apparatus progressively generates the content for each dialogue element using the prompt templates and a pre-trained large language model. By generating multi-round dialogue data for the target scenario based on the content corresponding to the user queries and response content, this method enables the fully automated generation of multi-round dialogue data in the target domain, eliminating the need for manual annotation, reducing data acquisition costs, and improving efficiency. Moreover, by controlling the pre-trained large language model with preset prompts and generating potential values for the dialogue elements in the target domain, the apparatus can generate various potential dialogue scenarios based on different values of the dialogue elements. This further facilitates the generation of user queries and response content for each scenario, expanding the coverage of the acquired dialogue data.

Furthermore, by setting prompt templates for each human-computer dialogue element and introducing dynamically generated input data via placeholders in the templates, the method for generating dialogue data becomes more flexible. For example, it allows for flexible control over the topic categories, response styles, and more, which helps with the upgrading and optimization of applications based on the dialogue data. By describing the content dependency relationships between different dialogue elements through placeholders in the prompt templates, the dialogue data generation strategy can be adjusted flexibly. This facilitates the generation of comprehensive multi-round dialogue data that aligns with real-world target scenarios.

On the other hand, in this embodiment, by setting prompt templates for each human-computer dialogue element and introducing content dependency relationships between the dialogue elements in the prompt templates, a pipeline approach is used to invoke these templates. This simplifies the design of the prompts and breaks down the process of generating multi-round dialogue data into multiple independent, sequential modules. This not only enhances the stability of each module but also improves the overall stability of the multi-round dialogue data generation process, helping to ensure the quality of the generated dialogue data.

Based on the above embodiments, this embodiment further provides a model training device, which includes:
Multi-round Dialogue Data Acquisition Module: this module is used to acquire several sets of multi-round dialogue data in the target scenario. Each set of multi-round dialogue data includes multiple rounds of user queries and response content arranged in a logical progression.
Model Construction Module: this module is used to construct a dialogue content generation model based on a pre-trained large language model;
Model Training Module: this module fine-tunes the dialogue content generation model based on the multi-round dialogue data until the predicted loss value of the model meets the preset convergence conditions. The predicted loss value is calculated based on the single-round dialogue prediction loss for each set of multi-round dialogue data. The single-round dialogue prediction loss is the negative log-likelihood (NLL) average, obtained by modeling the predicted response content generated by the model for the user queries in each round of the dialogue data.

In some optional embodiments, the Multi-round Dialogue Data Acquisition Module is further configured to:
obtaining the prompt word templates and the generation content dependency relationships corresponding to the human-computer dialogue elements in the target scenario, wherein the human-computer dialogue elements include: user queries and response content;
based on the content dependency relationships, progressively generate the corresponding content for each human-computer dialogue element using the prompt templates and the pre-trained large language model;
generating multi-round dialogue data for the target scenario based on the generation content corresponding to the user queries and response content.

The specific implementation details of each module in the model training apparatus can be referenced in the relevant descriptions from the embodiments of the model training method mentioned earlier. These details are not repeated here.

In summary, the model training apparatus disclosed in one embodiment of this application fine-tunes a dialogue content generation model, built on a pre-trained large language model, using several sets of multi-round dialogue data from a target scenario. The fine-tuning continues until the predicted loss value of the model meets preset convergence conditions. During the training process, the predicted loss value is calculated based on the single-round dialogue prediction loss for each set of multi-round dialogue data. This loss is computed as the average negative log-likelihood (NLL) of the predicted response content generated by the model for the user queries in each dialogue round. When conducting supervised fine-tuning using generated multi-round free-form dialogue data, the use of the NLL loss function focuses solely on modeling the response content. This helps reduce the impact of noise in user queries on language modeling, thereby improving the quality of the response content generated by the trained dialogue content generation model.

By using domain-specific corpora (e.g., in the e-commerce domain), the dialogue content generation model transitions from general-purpose capabilities to those specialized for the target domain. This enhances the model's understanding of knowledge within that specific domain. Through supervised fine-tuning using dialogue-structured corpora, the model is upgraded from simple text generation to handling multi-round dialogues. This enables the dialogue content generation model to acquire the free-form dialogue capabilities and service skills required by aₙ intelligent assistant operating in the target domain.

Based on the above embodiments, this embodiment further provides a dialogue processing device, which includes:
Dialogue Data Acquisition Module: this module is used to retrieve the specified number of previous dialogue rounds in response to receiving the current round of user queries.
Response-Ready Dialogue Data Generation Module: generating reply dialogue data to be responded to based on the current-round user query and the specified number of previous rounds of dialogue data, according to a logical progression;
Response Prediction Module: invoking a pre-trained dialogue content generation model based on the reply dialogue data to obtain response content output by the dialogue content generation model;
User Query Response Module: This module is used to respond to the current-round user query based on the response content.

The specific implementation details of each module in the dialogue processing apparatus can be referenced in the relevant descriptions from the previous embodiments of the dialogue data processing method. These details are not repeated here.

In summary, the dialogue processing apparatus disclosed in one embodiment of this application operates by, upon receiving a current round of user queries, further retrieving the specified number of previous dialogue rounds. Based on the current query and these previous rounds, the apparatus generates response-ready dialogue data following a logical progression. By predicting response content using multi-round dialogue data, it improves the matching accuracy between the user query and the response. Additionally, when invoking the pre-trained dialogue content generation model based on the response-ready dialogue data, the apparatus generates response content. When responding to the current round of user queries based on this content, the apparatus benefits from the strong domain-specific language understanding of the dialogue content generation model, which is built on a pre-trained large language model and fine-tuned using multi-round dialogue data from the target domain (such as e-commerce). This approach results in higher-quality responses tailored to specific user scenarios within the target domain.

This application embodiment also provides a non-volatile readable storage medium, which stores one or more modules (programs). When these modules are applied to a device, they enable the device to execute the instructions of method steps described in this application's embodiments.

This application embodiment further provides a computer-readable storage medium that stores computer-executable instructions. When executed by a processor, these instructions are used to implement the methods described in the embodiments of this application.

This application embodiment also provides an electronic device, which includes: a processor and a memory in communication with the processor. The memory stores computer-executable instructions, and the processor executes these instructions to implement the methods described in the embodiments of this application. In this embodiment, the electronic device may include servers, terminal devices, and other such equipment.

The embodiments of this disclosure can be implemented using any suitable hardware, firmware, software, or any combination thereof to achieve the desired configuration. This device may include servers (clusters), terminals, or other electronic devices. FIG. 6 schematically illustrates an exemplary device 600 that can be used to implement the various embodiments described in this application.

In one embodiment, FIG. 6 illustrates an exemplary device 600. The device includes one or more processors 602, a control module (chipset) 604 coupled to at least one of the processors 602, a memory 606 coupled to the control module 604, non-volatile memory (NVM) or storage device 608 coupled to the control module 604, one or more input/output (I/O) devices 610 coupled to the control module 604, and a network interface 612 coupled to the control module 604.

The processor 602 may include one or more single-core or multi-core processors, and it may consist of any combination of general-purpose processors or specialized processors (e.g., graphics processors, application processors, baseband processors, etc.). In some embodiments, device 600 can serve as the server, terminal, or other equipment described in this application's embodiments.

In some embodiments, device 600 may include one or more computer-readable media (e.g., memory 606 or NVM/storage device 608) that store instructions 614. These instructions, when executed by one or more processors 602, are configured to implement modules that perform the actions described in this disclosure.

In one embodiment, the control module 604 may include any suitable interface controller to provide aₙ appropriate interface for at least one of the processors 602 and/or any suitable device or component in communication with the control module 604.

The control module 604 may include a memory controller module to provide aₙ interface to the memory 606. The memory controller module can be a hardware module, a software module, and/or a firmware module.

The memory 606 may be used to load and store data and/or instructions 614 for device 600. In one embodiment, memory 606 may include any suitable volatile memory, such as DRAM. In some embodiments, memory 606 may include Double Data Rate 4 Synchronous Dynamic Random Access Memory (DDR4 SDRAM).

In one embodiment, the control module 604 may include one or more input/output controllers to provide aₙ interface to the NVM/storage device 608 and the one or more input/output (I/O) devices 610.

For example, the NVM/storage device 608 can be used to store data and/or instructions 614. The NVM/storage device 608 may include any suitable non-volatile memory (e.g., flash memory) and/or may include any suitable non-volatile storage devices (e.g., one or more hard disk drives (HDDs), one or more compact disc (CD) drives, and/or one or more digital versatile disc (DVD) drives).

The NVM/storage device 608 may include storage resources that are part of the device 600 on which it is installed, or it may be accessed by the device without being part of it. For example, the NVM/storage device 608 can be accessed via a network through one or more input/output (I/O) devices 610.

The one or more input/output (I/O) devices 610 provide aₙ interface for device 600 to communicate with any other suitable device. These I/O devices may include communication components, audio components, sensors, and more. The network interface 612 enables device 600 to communicate over one or more networks. Device 600 can communicate wirelessly with one or more components of a wireless network using any standard or protocol from a variety of wireless network standards, such as Bluetooth, Wi-Fi, 2G, 3G, 4G, 5G, or a combination of these for wireless communication.

In one embodiment, at least one of the processors 602 may be logically packaged together with one or more controllers of the control module 604 (e.g., the memory controller module). In another embodiment, at least one of the processors 602 may be logically packaged with one or more controllers of the control module 604 to form a System-in-Package (SiP). In yet another embodiment, at least one of the processors 602 may be logically integrated with one or more controllers of the control module 604 on the same die. Alternatively, at least one of the processors 602 may be integrated with one or more controllers of the control module 604 on the same die to form a System on Chip (SoC).

In various embodiments, device 600 can be, but is not limited to, a server, a desktop computing device, or a mobile computing device (e.g., a laptop, handheld device, tablet, netbook, etc.). In different embodiments, device 600 may have more or fewer components and/or a different architecture. For example, in some embodiments, device 600 may include one or more cameras, a keyboard, a liquid crystal display (LCD) screen (including a touchscreen display), non-volatile memory ports, multiple antennas, a graphics chip, aₙ application-specific integrated circuit (ASIC), and speakers.

The detection device can use a main control chip as the processor or control module. Sensor data, location information, and other relevant data can be stored in the memory or NVM/storage device. The sensor array can function as input/output devices, while the communication interface may include a network interface.

This application embodiment also provides an electronic device, which includes: a processor and a memory that stores executable code. When the executable code is executed, it enables the processor to perform one or more of the methods described in the embodiments of this application. In this embodiment, the memory can store various types of data, such as target files, file-to-application association data, and other types of data, including user behavior data. This stored data serves as a foundation for supporting various processing tasks.

This application embodiment also provides one or more machine-readable media, on which executable code is stored. When the executable code is executed, it enables the processor to perform one or more of the methods described in the embodiments of this application.

For the device embodiments, since they are essentially similar to the method embodiments, the description is relatively simplified. For relevant details, refer to the explanations provided in the method embodiments.

The various embodiments in this specification are described in a progressive manner, with each embodiment highlighting the differences from the others. For the similar or identical parts between embodiments, reference can be made to the descriptions in other embodiments.

The embodiments of this application are described with reference to flowcharts and/or block diagrams of methods, terminal devices (systems), and computer program products according to the embodiments. It should be understood that each flow and/or block in the flowcharts and/or block diagrams, as well as the combinations of flows and/or blocks, can be implemented by computer program instructions. These computer program instructions can be provided to a general-purpose computer, a special-purpose computer, an embedded processor, or other programmable data processing terminal device to produce a machine, such that the instructions executed by the processor of the computer or other programmable data processing terminal device create means for performing the functions specified in one or more flows or blocks of the flowchart and/or block diagram.

These computer program instructions can also be stored in a computer-readable storage medium that directs a computer or other programmable data processing terminal device to operate in a specific manner. The instructions stored in the computer-readable storage medium create aₙ article of manufacture that includes instruction means for implementing the functions specified in one or more flows of a flowchart and/or one or more blocks of a block diagram.

These computer program instructions can also be loaded onto a computer or other programmable data processing terminal device, causing the computer or other terminal device to execute a series of operational steps to produce a computer-implemented process. In this way, the instructions executed on the computer or other programmable terminal device provide steps for implementing the functions specified in one or more flows of a flowchart and/or one or more blocks of a block diagram.

Although the preferred embodiments of this application have been described, those skilled in the art, once they understand the basic inventive concept, may make further changes and modifications to these embodiments. Therefore, the appended claims are intended to be interpreted as including the preferred embodiments as well as all changes and modifications that fall within the scope of the embodiments of this application.

Finally, it should be noted that relational terms such as “first” and “second” are used solely to distinguish one entity or operation from another, and do not necessarily imply any actual relationship or order between these entities or operations. Additionally, terms like “comprise,” “include,” or any other variations are intended to cover non-exclusive inclusion. Thus, a process, method, article, or terminal device that includes a series of elements not only includes those elements but may also include other elements not explicitly listed, or elements inherent to such a process, method, article, or terminal device. Without additional limitations, an element defined by the phrase “comprising a . . . ” does not exclude the existence of additional identical elements in the process, method, article, or terminal device that includes the element.

The foregoing provides a detailed description of a dialogue data generation method, a dialogue data generation system, a model training method, a dialogue processing method, aₙ electronic device, and a storage medium as disclosed in this application. Specific examples have been used to explain the principles and embodiments of this application. The descriptions of these embodiments are intended to aid in understanding the methods and core concepts of this application. At the same time, those skilled in the art may make modifications to the specific embodiments and application scope based on the ideas of this application. Therefore, the content of this specification should not be construed as limiting the scope of this application.

What is claimed is:

1. A method for generating dialogue data, comprising:
obtaining a prompt template and a generation content dependency relationship corresponding to each of human-machine dialogue elements in a target scenario, wherein the human-machine dialogue elements at least include: user queries and response content;
progressively generating generation content of the corresponding human-machine dialogue elements based on the prompt templates and a pre-trained large language model according to the generation content dependency relationships;
generating multi-round dialogue data in the target scenario based on the generation content respectively corresponding to the user queries and the response content.

2. The method according to claim 1, wherein progressively generating the generation content of the corresponding human-machine dialogue elements based on the prompt templates and the pre-trained large language model according to the generation content dependency relationships comprises:
determining, according to the generation content dependency relationships, a first prompt template and a second prompt template from the prompt templates;
generating generation content of the corresponding human-machine dialogue elements based on the first prompt template and the pre-trained large language model;
progressively generating generation content of the corresponding human-machine dialogue elements based on the second prompt template, pre-generated target generation content, and the pre-trained large language model, according to the generation content dependency relationships.

3. The method according to claim 2, wherein generating the generation content of the corresponding human-machine dialogue elements based on the first prompt template and the pre-trained large language model comprises:
respectively using the first prompt template as a current prompt template, and performing the following first content generation operations:
generating a first current prompt based on the current prompt template;
invoking the pre-trained large language model based on the first current prompt to generate the generation content of the corresponding human-machine dialogue elements.

4. The method according to claim 2, wherein progressively generating the generation content of the corresponding human-machine dialogue elements based on the second prompt template, the pre-generated target generation content, and the pre-trained large language model according to the generation content dependency relationships comprises:
determining, based on the generation content dependency relationships, a generation order of the generation content corresponding to the human-machine dialogue elements for the second prompt template;
sequentially executing second content generation operations from first to last according to the generation order, wherein the second content generation operations comprise:
obtaining, based on the generation content dependency relationships, pre-generated generation content on which the generation content of a current human-machine dialogue element depends, as the target generation content;
formatting the second prompt template corresponding to the current human-machine dialogue element based on the target generation content, to generate a second current prompt;
invoking the pre-trained large language model based on the second current prompt to generate the generation content of the current human-machine dialogue element.

5. The method according to claim 1, wherein the generation content dependency relationships are represented by placeholders set in the prompt templates.

6. The method according to claim 5, wherein the prompt templates represent, through placeholders corresponding to a first human-machine dialogue element, that input conditions on which the generation of the generation content of a second human-machine dialogue element depends include the generation content of the first human-machine dialogue element, wherein the second human-machine dialogue element is the human-machine dialogue element corresponding to the prompt template.

7. The method according to claim 1, wherein the prompt template corresponding to the user queries includes a rule prompt, the rule prompt being used to instruct the pre-trained large language model to generate user queries according to a first rule, wherein the first rule includes: each group of generated user queries has relevance and a logical progression, and incorporates at least N instances of context, where N is a natural number greater than 1.

8. The method according to claim 1, wherein the prompt template corresponding to the response content includes an instruction prompt, the instruction prompt being used to instruct the pre-trained large language model to generate the response content to a final-round user query in dialogue context based on prior dialogue context.

9. The method according to claim 1, wherein the user queries have a logical progression, and the response content corresponds to the user queries, the multi-round dialogue data in the target scenario being generated based on the generation content corresponding to the user queries and the response content, comprising:
for each group of user queries, constructing an ordered combination of multi-round question-answer pairs corresponding to each group of user queries based on the user queries and the corresponding response content, according to the logical progression of the user queries;
generating the multi-round dialogue data in the target scenario based on the ordered combination.

10. A method for training a model, comprising:
obtaining multiple sets of multi-round dialogue data in a target scenario, wherein each set of the multi-round dialogue data comprises: multi-round user queries and response content arranged in a logically progressive sequence;
constructing a dialogue content generation model based on a pre-trained large language model;
fine-tuning the dialogue content generation model based on the multiple sets of multi-round dialogue data until predicted loss value of the dialogue content generation model satisfies a preset convergence condition, wherein the predicted loss value is calculated based on single-round dialogue prediction loss of each set of multi-round dialogue data, and the single-round dialogue prediction loss is negative log-likelihood mean obtained by modeling predicted response content generated by the dialogue content generation model in response to the user queries in each round of dialogue data.

11. A method for processing a dialogue, comprising:
in response to receiving a current-round user query, obtaining dialogue data from a specified number of previous rounds of dialogue;
generating reply dialogue data to be responded to based on the current-round user query and the specified number of previous rounds of dialogue data, according to a logical progression;
invoking a pre-trained dialogue content generation model based on the reply dialogue data to obtain response content output by the pre-trained dialogue content generation model;
responding to the current-round user query based on the response content.

12. The according to claim 11, wherein the pre-trained dialogue content generation model is trained by:
obtaining multiple sets of multi-round dialogue data in a target scenario, wherein each set of the multi-round dialogue data comprises: multi-round user queries and response content arranged in a logically progressive sequence;
constructing a dialogue content generation model based on a pre-trained large language model;
fine-tuning the dialogue content generation model based on the multiple sets of multi-round dialogue data until predicted loss value of the dialogue content generation model satisfies a preset convergence condition, wherein the predicted loss value is calculated based on single-round dialogue prediction loss of each set of multi-round dialogue data, and the single-round dialogue prediction loss is negative log-likelihood mean obtained by modeling predicted response content generated by the dialogue content generation model in response to the user queries in each round of dialogue data.
